(19) United States
(12) Patent Application Publication
(10) Pub. No.: US 2025/0005326 A1
(43) Pub. Date: Jan. 2, 2025

(54) REUSING WEIGHTS AND BIASES IN AN ARTIFICIAL INTELLIGENCE ACCELERATOR FOR A NEURAL NETWORK FOR DIFFERENT MINIBATCH SIZES OF INFERENCES

(71) Applicant: INTERNATIONAL BUSINESS MACHINES CORPORATION, Armonk, NY (US)

(72) Inventors: Swagath Venkataramani, White Plains, NY (US); Marcel Schaal, Fort Montgomery, NY (US); Sanchari Sen, White Plains, NY (US); Amrit Nagarajan, West Lafayette, IN (US); Vijayalakshmi Srinivasan, New York, NY (US); Shyam Ramji, LaGrange, NY (US)

(21) Appl. No.: 18/344,491

(22) Filed: Jun. 29, 2023

(51) Int. Cl. G06N 3/045

(52) U.S. Cl. CPC G06N 3/045

(57) ABSTRACT

Provided are a computer program product, system, and method for reusing weights and biases in an artificial intelligence accelerator for a neural network for different minibatch sizes of inferences. A minibatch size is selected of inference jobs batched to process in the accelerator. A representation of a neural network is processed to determine a set of weights and biases for the selected minibatch size to load into the core. The set of weights and biases is loaded into the core for use by the array of processing elements in the core of the accelerator. The weights and the biases are reused in the processing elements for the neural network, loaded for the selected minibatch size, to apply to minibatches of inferences having minibatch sizes less than the selected minibatch size.

### BACKGROUND

### 1. Field of the Invention

The present invention relates to a computer program product, system, and method for reusing weights and biases in an artificial intelligence accelerator for a neural network for different minibatch sizes of inferences.

### 2. Description of the Related Art

Artificial intelligence (AI) applications including deep neural networks (DNNs), Generative Adversarial Networks (GANs), and natural language processors that operate on images, videos, text and natural language have very high computational costs. To address the high computational costs, specialized hardware devices known as AI accelerators have been developed to process offloaded AI workloads. An AI accelerator has an array of processing elements (PEs) supporting computations to execute convolution and matrix multiplication operations. The AI accelerator loads weights and biases of a neural network onto AI accelerator for the core array of PEs to use to process input data for inferences, such as images, text, video, language, to generate the desired output. The neural network weights and biases remain static in the core and are used to process multiple inferences, or AI jobs.

### BRIEF DESCRIPTION OF THE DRAWINGS

Referring now to the drawings in which like reference numbers represent corresponding parts throughout:

FIG. 1 illustrates an embodiment of an inference server having an AI accelerator.

FIG. 2 illustrates an embodiment of an AI accelerator chip in which the AI accelerator is implemented.

FIG. 3 illustrates an embodiment of a core on the AI accelerator chip comprised of an array of processing elements.

FIG. 4 illustrates an embodiment of operations to compile program binaries for minibatches for neural networks implemented in the AI accelerator.

FIG. 5 illustrates an embodiment of operations to process a minibatch of inferences in the AI accelerator.

FIG. 6 illustrates a computing environment in which the components of FIG. 1 may be implemented.

### SUMMARY

Provided are a computer program product, system, and method for reusing weights and biases in an artificial intelligence accelerator for a neural network for different minibatch sizes of inferences. A minibatch size is selected of inference jobs batched to process in the accelerator. A representation of a neural network is processed to determine a set of weights and biases for the selected minibatch size to load into the core. The set of weights and biases is loaded into the core for use by the array of processing elements in the core of the accelerator. The weights and the biases are reused in the processing elements for the neural network, loaded for the selected minibatch size, to apply to minibatches of inferences having minibatch sizes less than the selected minibatch size.

### DETAILED DESCRIPTION

AI jobs, also known as inferences having input data to process, are batched in a minibatch. A minibatch size refers to a number of inferences batched in a minibatch. A compiler may compile program binaries for the PEs in an array for different minibatch sizes for a neural network, including weights and biases to load into the array of PEs for a minibatch size. The program binaries and weights and biases for a particular minibatch size are loaded into a core of the AI accelerator when processing a minibatch of a specific size.

A latency is introduced into the AI accelerator processing when having to load neural network weights and biases in the AI accelerator for a new minibatch size being processed because each minibatch size has its own optimized configuration of weights and biases to load in a core of the AI accelerator for use by the processing elements in the core. The compiler generates an optimized configuration of weights and biases for each possible minibatch size that needs to be loaded into the AI accelerator when switching to processing a minibatch of inferences of a new size. This need to load in a new configuration of weights and biases into the core each time a different minibatch size of inferences is processed introduces latency into the AI processing.

Described embodiments provide improvements to AI accelerator technology for compiling program binaries for minibatches of different sizes for a neural network and managing those program binaries when processing minibatches of different sizes for the neural network during AI execution time. Described embodiments determine a minibatch size that optimizes AI processing. For instance, if the minibatch size, i.e., number of inferences, is too small, then the AI accelerator cores are underutilized and throughput is not optimized. However, if the batch size is too large, then the activation sizes are too large and the inferences need to be written and fetched from external memory before being processed by the array of PEs, which is expensive. Described embodiments determine an optimal batch size for a neural network that provides the maximum batch size, or throughput, while still maintaining latency within a latency requirement of the processing, such as dictated by a quality of service provided for the inferences. Once the optimal minibatch size of inferences is determined, when processing a neural network, the weights and biases for the optimal minibatch size are loaded into the core of the AI accelerator and used by the array of PEs for processing minibatches of inferences of different sizes for the neural network. In this way, latency is not introduced by switching between processing different minibatch sizes, because the same weights and biases are reused for all minibatch sizes. This avoids the latency cost of switching out weights and biases from the array of PEs when alternating processing minibatches of different sizes.

Yet further, with described embodiments, the optimal weights and biases for the optimal minibatch size are used because using optimal weights and bases for the optimal minibatch size maximizes throughput in the AI processing within a latency requirement/constraint.

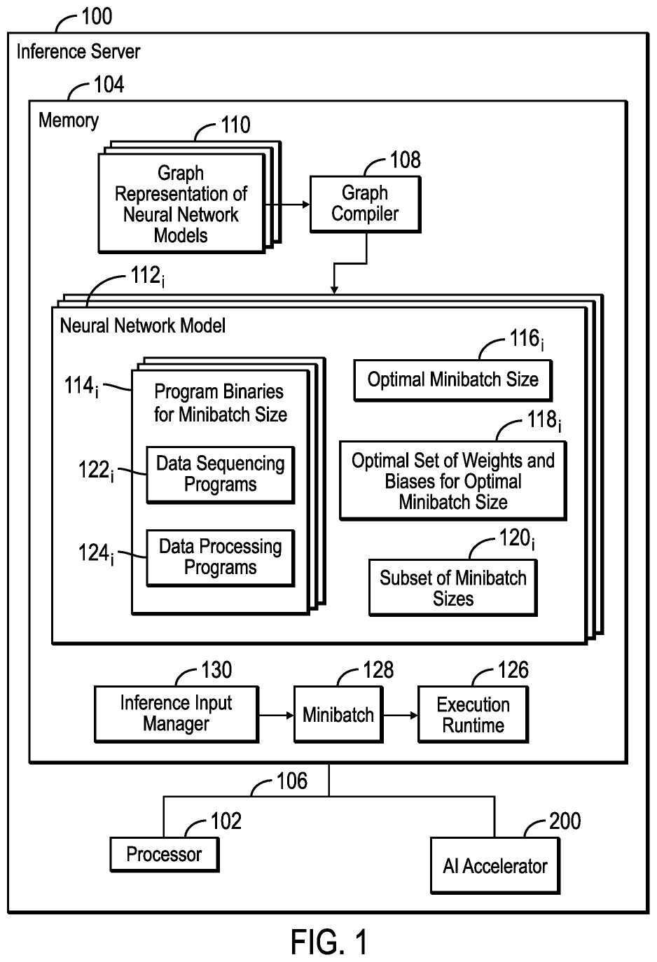

FIG. 1 illustrates an embodiment of an inference server 100 having a processor 102, having one or more cores, a memory 104, and an artificial intelligence (“AI”) accelerator 200 to process minibatches of inferences having data inputs to subject to neural network processing, such as a deep neural network (“DNN”). The components 102, 104, and 200 may communicate over a bus interface 106, such as a Peripheral Component Interconnect Express (PCIe) bus.

The inference server 100 may be utilized in a server or enterprise system to provide dedicated on-chip AI acceleration. The AI accelerator 200 may comprise an on-chip AI accelerator that enables generating real-time insights from inferences, each inference having input data for which an inference output is to be generated. The AI accelerator 200 provides consistent low latency and high throughput (e.g., over 200 TFLOPS in 32 chip system) inference capacity usable by all threads. The AI accelerator 200 is memory coherent and directly connected to the fabric like other general-purpose core to support low latency inference while meeting the system's transaction rate. A scalable architecture providing transparent access to AI accelerator functions via a non-privileged general-purpose core instruction further reduces software orchestration and library complexity as well as provides extensibility to the AI functions.

The memory 104 includes a graph compiler 108 that receives as input graph representations of neural network models 110, such as in a high-level framework, e.g., PyTorch, TensorFlow, etc. For each neural network model 110ᵢ, the compiler 108 automatically identifies how best to execute a given neural network graph on the AI accelerator 200 and constructs the program binaries 114ᵢ to execute the neural network graph 110ᵢ. The graph compiler 108 determines an optimal minibatch size 116ᵢ for neural network i, which may comprise the maximum batch size at which the latency to complete generating the inference output can satisfy a latency constraint. This optimal minibatch size 116ᵢ maximizes throughput and maintains a required latency. The graph compiler 108 generates an optimal set of weights and biases 118ᵢ for the optimal minibatch size 116ᵢ for neural network 112ᵢ. The graph compiler 108 may also determine a subset of minibatch sizes 120ᵢ, less than and including the optimal minibatch size for which program binaries 114ᵢ will be generated. This subset of minibatch sizes 120ᵢ may comprise the minimal set of minibatch sizes that can add up to any minibatch size from the optimal minibatch size 116ᵢ to a size of one inference. The program binaries 114ᵢ the compiler 108 generates for each of the minibatch sizes in the subset 120ᵢ include data sequencing programs 122ᵢ, which load/store data from the scratchpad memories and feed them in sequence to processing elements (PE) and special function units (SFUs) on arrays on cores of the AI accelerator 200, and data processing programs 124ᵢ, which define the set of computations executed on PE/SFUs on the incoming data elements in the inferences in a minibatch of the minibatch size.

The memory 104 further includes an execution runtime module 126 which receives a minibatch of inferences 128, and their data elements to process, from the inference input manager 130. Further, if the number of jobs or inferences are small, then the small number of inferences may be batched into a minibatch or a batch size smaller than a minibatch if jobs are not received within a predetermined time The execution runtime 126 maps the input data form the inferences to the PEs and SFUs on the cores of the AI accelerator 200, and triggers and manages the execution of compute and data-transfer operations on the AI accelerator 200.

The arrows shown in FIG. 1 between the components and objects represent a data flow between the components.

Generally, program modules, such as the program components 108, 114ᵢ, 122ᵢ, 124ᵢ, 126, 130, among others, may comprise routines, programs, objects, components, logic, data structures, and so on that perform particular tasks or implement particular abstract data types. The program components and hardware devices of the inference server 100 and AI accelerator 200 may be implemented in one or more computer systems, where if they are implemented in multiple computer systems, then the computer systems may communicate over a network.

The program components 108, 114ᵢ, 122ᵢ, 124ᵢ, 126, 130, among others, may be accessed by a processor from memory to execute. Alternatively, some or all of the program components 108, 114ᵢ, 122ᵢ, 124ᵢ, 126, 130, among others, among others, may be implemented in separate hardware devices, such as Application Specific Integrated Circuit (ASIC) hardware devices and accelerator engines.

The functions described as performed by the program 108, 114ᵢ, 122ᵢ, 124ᵢ, 126, 130, among others, may be implemented as program code in fewer program modules than shown or implemented as program code throughout a greater number of program modules than shown.

The inference server 100 may comprise an enterprise class machine deployed in the cloud to process inference requests according to the AI accelerator 200 to generate output. Further, the inference server 100 may comprise an edge AI device deployed close to the user to process inference requests close to the user.

The AI accelerator 200 may implement one or more of the same type or different types of neural networks, such as deep neural network (DNN) s, recurrent neural networks (RNN), Feedforward neural networks, Convolutional Neural Networks (CNN), Deep Convolutional Neural Networks (DCNNs), Generative Adversarial Network (GAN), Conditional GAN (cGAN), Perceptron, Multilayer perceptron, radial basis functional neural network, Long Short-Term Memory (LSTM), sequence to sequence models, modular neural network, and implement other algorithms, such as such as decision tree learning, association rule learning, neural networks, inductive programming logic, support vector machines, Bayesian network, transformers, etc.

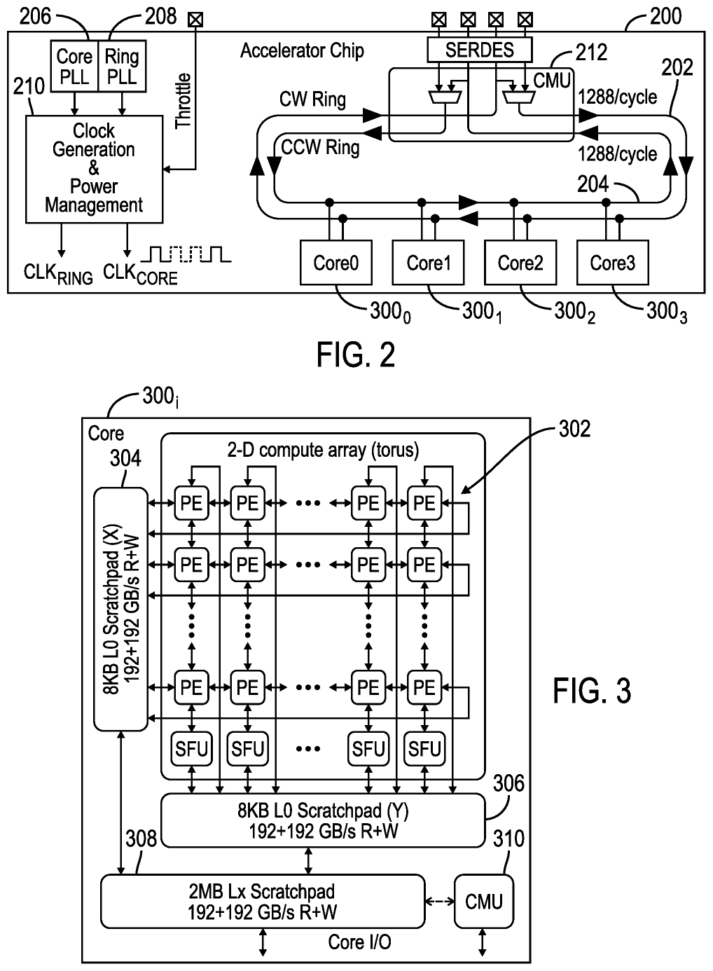

FIG. 2 illustrates an embodiment of the AI accelerator 200 architecture and dataflow in accordance with certain embodiments. The AI accelerator 200 is designed to provide enough compute performance to accommodate the maximum sustained system data bandwidth for long running systolic operations, while the performance of concurrently running virtual machines or partitions is not noticeably affected. Furthermore, the design matches the peak on-chip data bandwidth for short running elementwise or activation AI functions, and hence gets the maximum possible speed up for these functions.

In the implementation of FIG. 2, the AI accelerator 200 includes a plurality of cores 300₀, 300₁, 300₂, 300₃ connected to a bi-directional clockwise (CW) 202 and counter-clockwise (CCW) 204 rings. The ring and the cores operate in asynchronous clock domains with separate core 206 and ring 208 PLLs so as to optimally balance power/performance for compute and data movement. Cores 300₀, 300₁, 300₂, 300₃ communicate with each other and with memory using the memory/neighbor interface and the ring interface unit across the asynchronous boundary. To enable scaling to a larger system, the rings are connected through a chip management unit (CMU) 212 that can either close the rings within a single accelerator chip or connect multiple chips to form manycore systems. The accelerator AI chip 200 also includes power management 210 to implement the power for the chip 200. In alternative embodiments, alternative chip architectures that differ from FIG. 2 may be used to implement and interconnect the cores 300₀, 300₁, 300₂, 300₃ or any number of cores.

FIG. 3 illustrates an embodiment of a core 300ᵢ, such as one of the cores 300₀, 300₁, 300₂, 300₃, on AI accelerator 200. A compute array 302 is arranged in a 2-dimensional torus of processing elements (PEs). Each PE comprises a single instruction multiple data (SIMD) engine comprising a tiny core, including an instruction buffer, fetch/decode stage, register file, floating-point execution units, and binary and ternary Arithmetic Logic Units (ALUs), and fabric links to and from the neighboring PEs. The execution units handle basic operations such as multiply-add with estimation for many non-linear functions such as square root or reciprocal. The bottom row of the compute array is a set of special function units (SFUs) that are similar to the PEs, but with support for higher-precision 32-bit FP math and datatype conversion between 16-bit and 32-bit. In one implementation, the array 302 may comprise 32 PEs or SFUs horizontally by 16 PEs and 1 SFU vertically.

Data arrives into the compute array 302 from a two-level scratchpad. Two 8 KB L0 scratch pads 304 and 306 are positioned along different dimensions of the torus array 302, backed up by a shared 2 MB scratchpad 308. In a weight stationary approach, the weights of the neural network are stored in the local registers, but move input data and partial sums through the fabric and scratchpads. An output stationary approach moves the inputs and the weights, but keeps the partial sums in the local register file. A row stationary approach exploits locality in multiple dimensions, by mapping a row of weights (e.g., one dimension of a convolution) and a row of inputs to each PE, and then combining together different results to generate the partial sums. A chip management unit (CMU) 310 may comprise the CMU 212 (FIG. 2) to connect a core to other cores in the AI accelerator 200. Further, one core may include multiple arrays 302.

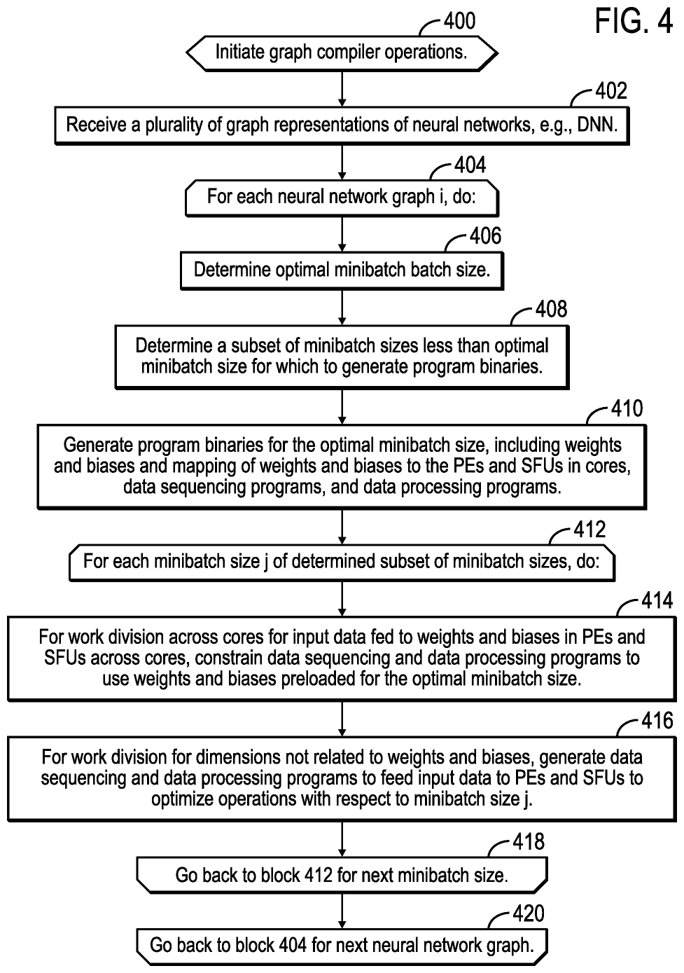

FIG. 4 illustrates an embodiment of graph compiler 108 operations to compile program binaries 114₁ . . . 114ₙ for neural network models to be available for immediate use to process minibatches of inferences for the neural network models. The graph compiler 108 receives (at block 402) a plurality of graph representations of neural networks 110, e.g., DNNs. A loop of operations is performed at blocks 404 through 420 for each of the neural network graphs 110 received. For neural network graph 110ᵢ, a determination (at block 406) is made of an optimal minibatch size 116ᵢ, comprising a maximum number of inferences that when processed have a latency less than a required latency. The graph compiler 108 determines (at block 408) a subset of minibatch sizes 120ᵢ less than optimal minibatch size for which to generate program binaries 114ᵢ. The subset 120ᵢ may comprise a minimum number of sizes including the optimal minibatch size 116ᵢ that can be combined to form any number of minibatch sizes, less than the optimal minibatch size 116ᵢ. The graph compiler 108 generates (at block 410) program binaries 1140, where “O” is for optimal, for the optimal minibatch size 116ᵢ, including the optimal set of weights and biases 118ᵢ and a configuration to map the optimal set of weights and biases 118ᵢ to the PEs and SFUs in arrays 302 in one or more cores 300ᵢ, data sequencing programs 122_{O}, and data processing programs 124_{O}. A loop of operations is performed at blocks 412 through 418 for each minibatch size j of the subset of minibatch sizes 120ᵢ. At block 414, for work division to feed inference input to the weights and biases in the array of PEs and SFUs 302 across cores, the graph compiler 108 constrains the data sequencing 122ᵢ and data processing 124ᵢ program operations to use weights and biases 118ᵢ preloaded for the optimal minibatch size 116ᵢ. For work division for dimensions not related to the neural network weights and biases, the graph compiler 108 generates (at block 416) data sequencing 122ᵢ and data processing 124ᵢ program operations to feed input data to PEs and SFUs to optimize operations with respect to minibatch size j.

In an example implementation, add operation on an input tensor is (mb*C*M*N), where mb is the minibatch size or number of inferences providing input data, M*N are the features or input elements for an inference, and the biases are a single dimensional vector of size “C” and reused along mb×M×N. In such case, the configuration of the weights and biases may specify an mb×M×N bias tensor to operate on all input features of each inference that is executed on arrays 302 across two cores 0 and 1, where the weights applied to the M×N features are split between the cores 0 and 1. For instance, core 0 may contain (0:M/2, 0:N/2) weights of the bias tensor and core 1 may contain (M/2:M, N/2:N) of the weights and biases for the optimal batch size. In this example, M and N are the weight-related dimensions for all batch sizes, so the features or input elements of the input tensor for an inference are split between the cores for correct functionality ((0:M/2, 0:N/2) in core 0, (M/2:M, N/2:N) in core 1. However, certain of the inputs are not weight and bias related, such as Mb and C. These input values can be split differently to optimize for different batch sizes. For instance, for a minibatch size of 2, the Mb data may be split by 2 along the Mb dimension and for batch size 2, the data may be split by 2 along C, as opposed to M×N, for a batch size of 1.

With the embodiment of FIG. 4, for each neural network model, the weights and biases for the optimal minibatch size are preloaded into the core 300; for use by the PEs and SFUs of the processing array 302 to be reused for any minibatch size of inferences received. This allows interferences in minibatches of different sizes for a neural network model to be processed without delays to load the weights and biases for the different minibatch sizes into the cores for the use by the PEs and SFUs because the weights and biases for the optimal minibatch size are retained and used for all minibatch sizes for a specific neural network.

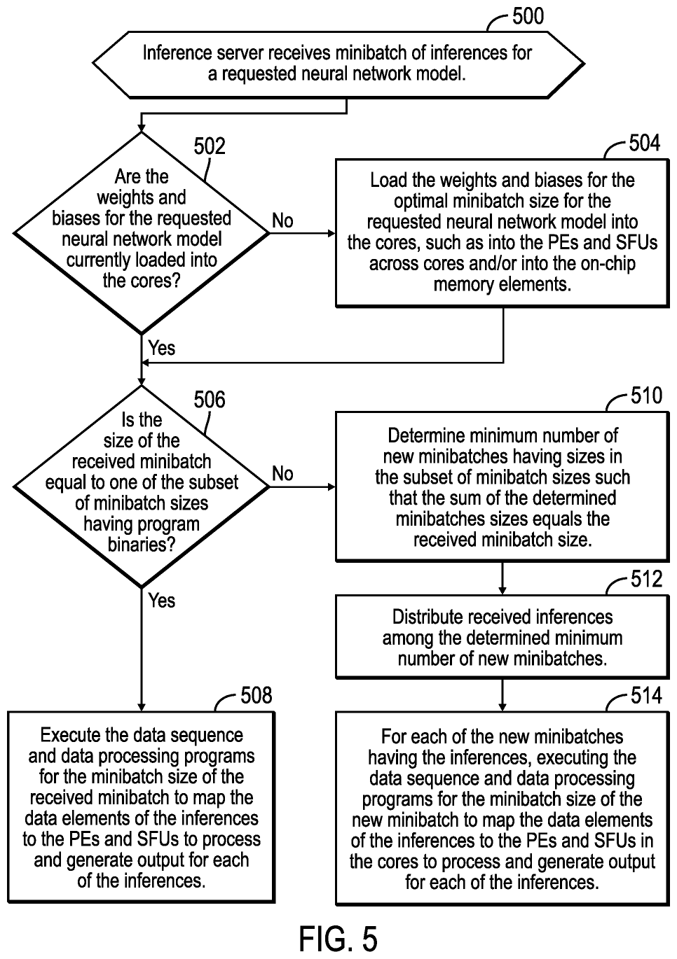

FIG. 5 illustrates an embodiment of operations performed by the execution runtime 126 to perform neural network transformations on a minibatch of inferences 128 received from the inference input manager 130 for processing by a requested neural network i. Upon the inference server 100 receiving a minibatch of inferences 128, if (at block 502) the optimal weights and biases 118ᵢ, for the neural network model i which the minibatch of inferences 128 was received, is not currently loaded in the cores 300₀ . . . 300₃ of the AI accelerator 200, then the optimal weights and biases 118ᵢ for the requested neural network are loaded (at block 504) into the AI accelerator 200 cores 300; to be accessible to processing arrays 302 across one or more cores 300₀ . . . 300₃. The weights and biases 118ᵢ may be loaded into the processing elements (PEs) and SFU's directly or loaded into on-chip memory elements, such as the scratchpads 304, 306 and/or 308, for access by the processing elements PEs and SFUs.

If the inference server 100 receives a small number of jobs, such as less than the minibatch size, then the execution runtime 126 collects jobs to add up to the optimal batch size and then dispatches the optimal batch size of jobs to the AI accelerator 200. In certain operational situations where no jobs arrive within a predetermined period of time or only a small number of jobs less than the minibatch size of jobs arrives within a period of time, then the execution runtime 126 dispatches a small batch size of jobs, less than the minibatch size, to meet a tail latency constraint.

If (from the YES branch of block 502) the optimal weights and biases 118ᵢ for the requested neural network model i to process the received minibatch 128 are already loaded into the AI accelerator 200 processor arrays 302 or after loading the weights and biases 118ᵢ (at block 504), the execution runtime 126 determines (at block 506) whether the received minibatch 128 size is equal to one of the subset of minibatch sizes 120ᵢ for neural network i. If (at block 506) the received minibatch 128 size is the same size of one of the subset of minibatch sizes 120ᵢ for which program binaries for neural network i were generated, then the program binaries 114ᵢ for the minibatch size of the received minibatch 128 are executed (at block 508) to process the inferences input data in the received minibatch 128. If (at block 506) the size of the received minibatch 128 is not of one of the subset of minibatch sizes 120ᵢ, then the execution runtime 126 determines (at block 510) a minimum number of minibatches having sizes in the subset of minibatch sizes 120ᵢ such that the sum of the sizes of the determined minibatches equals the received minibatch 128 size. The inferences in the received minibatch 128 are distributed (at block 512) to the determined number of minibatches having sizes in the subset of minibatch sizes 120ᵢ.

For each of the new minibatches having the inferences in the received minibatch 128, the execution runtime 126 executes (at block 514) the data sequence 122ᵢ and data processing 124ᵢ programs for the minibatch size of the new minibatch to map the data elements of the inferences in the new minibatch to the PEs and SFUs in the cores to process and generate output for each of the inferences.

With the described embodiments, latency of processing multiple minibatches for a same neural network is minimized by using the same optimal set of weights and biases 118ᵢ for the optimal minibatch size for different minibatch sizes being processed. This avoids the need to reload weights and biases for different minibatch sizes of a same neural network to process. Further, by generating only program binaries for a limited number of minibatch sizes, which are optimized to process minibatches of the size with respect to dimensions other than weights and biases of the neural network, the compile time and amount of storage needed for the program binaries is limited. Described embodiments allow only a limited number of program binaries for a subset of minibatch sizes 120ᵢ. Inferences in a minibatch having a size not in the subset of minibatch sizes may be repackaged into minibatches of the subset of minibatch sizes and processed using the program binaries for the repackaged minibatch sizes having the inferences from the received minibatch 128.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

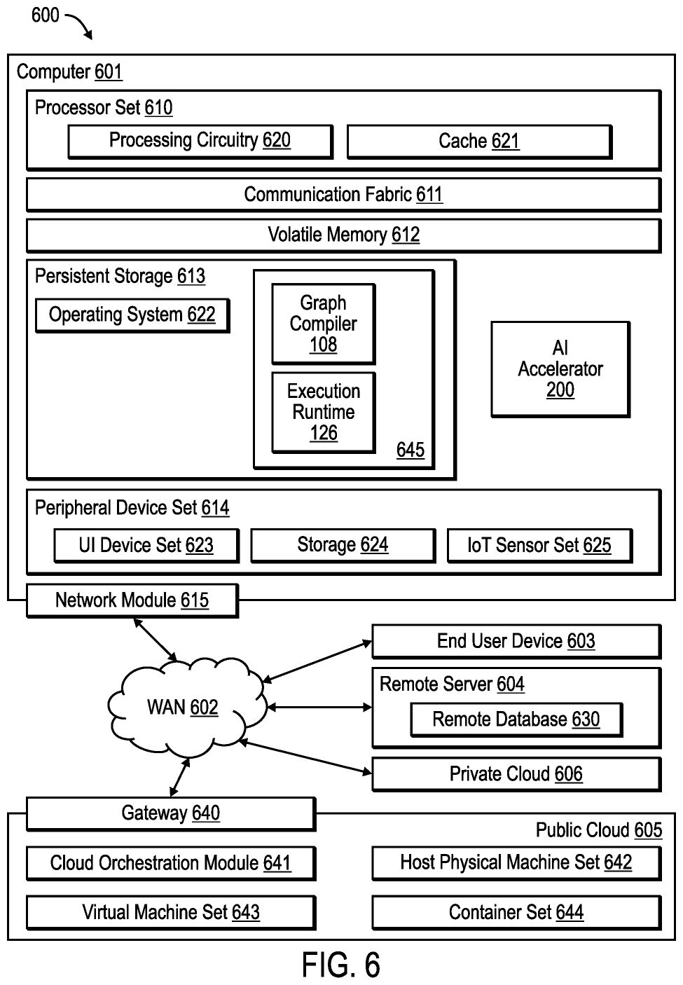

With respect to FIG. 6, computing environment 600 contains an example of an environment for the execution of at least some of the computer code involved in performing the inventive methods to compile program binaries for different minibatch sizes of a neural network to be processed in an AI accelerator 200, including a graph compiler 108 and execution runtime 126, described with respect to FIG. 1 in block 645. In addition to block 200, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 645, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 645 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface-type operating systems that employ a kernel. The code included in block 645 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on. The EUDs 603 may submit inferences to the computer 601 for processing by the neural network in the AI accelerator 200 to produce output based on the input inferences.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The letter designators, such as i, j, n, are used to designate a number of instances of an element may indicate a variable number of instances of that element when used with the same or different elements.

The terms “an embodiment”, “embodiment”, “embodiments”, “the embodiment”, “the embodiments”. “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

1. A computer program product for using weights and biases for a neural network in an array of processing elements in a core of an accelerator, the computer program product comprising a computer readable storage medium having computer readable program code embodied therein that is executable to perform operations, the operations comprising:
selecting a minibatch size of inference jobs batched to process in the accelerator;
processing a representation of a neural network to determine a set of weights and biases for the selected minibatch size to load into the core;
loading the set of weights and biases into the core for use by the array of processing elements in the core of the accelerator; and
reusing the weights and the biases in the processing elements for the neural network, loaded for the selected minibatch size, to apply to minibatches of inferences having minibatch sizes less than the selected minibatch size.

2. The computer program product of claim 1, wherein the selecting the minibatch size comprises:
determining an optimal minibatch size of inferences to input into the array of processing elements to maximize throughput within a latency constraint, wherein the selected minibatch size comprises the optimal minibatch size.

3. The computer program product of claim 2, wherein the operations further comprise:
receiving input data for inferences in a large minibatch having a size greater than the optimal minibatch size; and
forming a plurality of minibatches having a size less than or equal to the optimal minibatch size including the inferences in the large minibatch, wherein the formed plurality of minibatches include at least one minibatch having the optimal minibatch size.

4. The computer program product of claim 1, wherein the operations of selecting a minibatch size and processing the representation of the neural network to determine the set of weights and biases are performed for a plurality of neural network models.

5. The computer program product of claim 4, wherein the plurality of neural network models comprises a first neural network model and a second neural network model, wherein the set of weights and biases comprises a first set of weights and biases, wherein the loading the first set of weights and biases into the core and the reusing the first set weights and the biases in the processing elements to process input data for inferences are performed for the first neural network model, wherein the operations further comprise:
processing a representation of the second neural network model to determine a second set of weights and biases to load into the core to be accessible to the array of processing elements in the core;
loading the second set of weights and biases for the second neural network model into the core to be accessible to the array of processing elements in the core; and
reusing the second set of weights and biases in the processing elements to process minibatches of inferences for the second neural network model having different minibatch sizes.

6. The computer program product of claim 1, wherein the operations further comprise:
generating program binaries for the selected minibatch size and for a plurality of minibatch sizes less than the selected minibatch size, wherein program binaries for a minibatch size less than the selected minibatch size are configured to map input data, for the inferences in a minibatch of the minibatch size less than the selected minibatch size, to the processing elements having the weights and biases for the selected minibatch size.

7. The computer program product of claim 6, wherein the operations further comprise:
determining a minibatch size of input data for at least one inference.
selecting the program binaries for the determined minibatch size; and
executing the selected program binaries to map the input data for the at least one inference to the processing elements to apply the weights and biases to the input data to produce output data.

8. The computer program product of claim 6, wherein the program binaries generated for the minibatch sizes less than the selected minibatch size constrain a mapping of input data to the processing elements for processing dimensions related to applying the weights and biases for the selected minibatch size, and wherein the program binaries optimize work division with respect to the minibatch size less than the selected minibatch size for operations unrelated related to applying the weights and the biases.

9. The computer program product of claim 1, wherein the processing elements having the weights and biases are on a first core and a second core, wherein each of the first and second cores comprises arrays of processing elements, wherein the loading the set of weights and biases into the core comprises loading a first group of weights and biases in the set of weights and biases into the first core and loading a second group of the set of weights and biases into the second core, wherein input data for inferences for one of the minibatch sizes less than the selected minibatch sizes are split between the cores based on the weights and biases for the selected minibatch size.

10. A system for using weights and biases for a neural network in an array of processing elements in a core of an accelerator, comprising:
an accelerator;
a processor; and
a computer readable storage medium having computer readable program code embodied therein that when executed by the processor performs operations, the operations comprising:
selecting a minibatch size of inference jobs batched to process in the accelerator;
processing a representation of a neural network to determine a set of weights and biases for the selected minibatch size to load into the core;
loading the set of weights and biases into the core for use by the array of processing elements in the core of the accelerator; and
reusing the weights and the biases in the processing elements for the neural network, loaded for the selected minibatch size, to apply to minibatches of inferences having minibatch sizes less than the selected minibatch size.

11. The system of claim 10, wherein the selecting the minibatch size comprises:
determining an optimal minibatch size of inferences to input into the array of processing elements to maximize throughput within a latency constraint, wherein the selected minibatch size comprises the optimal minibatch size.

12. The system of claim 11, wherein the operations further comprise:
receiving input data for inferences in a large minibatch having a size greater than the optimal minibatch size; and
forming a plurality of minibatches having a size less than or equal to the optimal minibatch size including the inferences in the large minibatch, wherein the formed plurality of minibatches include at least one minibatch having the optimal minibatch size.

13. The system of claim 10, wherein the operations further comprise:
generating program binaries for the selected minibatch size and for a plurality of minibatch sizes less than the selected minibatch size, wherein program binaries for a minibatch size less than the selected minibatch size are configured to map input data, for the inferences in a minibatch of the minibatch size less than the selected minibatch size, to the processing elements having the weights and biases for the selected minibatch size.

14. The system of claim 13, wherein the program binaries generated for the minibatch sizes less than the selected minibatch size constrain a mapping of input data to the processing elements for processing dimensions related to applying the weights and biases for the selected minibatch size, and wherein the program binaries optimize work division with respect to the minibatch size less than the selected minibatch size for operations unrelated related to applying the weights and the biases.

15. The system of claim 10, wherein the processing elements having the weights and biases are on a first core and a second core, wherein each of the first and second cores comprises arrays of processing elements, wherein the loading the set of weights and biases into the core comprises loading a first group of weights and biases in the set of weights and biases into the first core and loading a second group of the set of weights and biases into the second core, wherein input data for inferences for one of the minibatch sizes less than the selected minibatch sizes are split between the cores based on the weights and biases for the selected minibatch size.

16. A method for using weights and biases for a neural network in an array of processing elements in a core of an accelerator, comprising:
selecting a minibatch size of inference jobs batched to process in the accelerator;
processing a representation of a neural network to determine a set of weights and biases for the selected minibatch size to load into the core;
loading the set of weights and biases into the core for use by the array of processing elements in the core of the accelerator; and
reusing the weights and the biases in the processing elements for the neural network, loaded for the selected minibatch size, to apply to minibatches of inferences having minibatch sizes less than the selected minibatch size.

17. The method of claim 16, wherein the selecting the minibatch size comprises:
determining an optimal minibatch size of inferences to input into the array of processing elements to maximize throughput within a latency constraint, wherein the selected minibatch size comprises the optimal minibatch size.

18. The method of claim 17, further comprising:
receiving input data for inferences in a large minibatch having a size greater than the optimal minibatch size; and
forming a plurality of minibatches having a size less than or equal to the optimal minibatch size including the inferences in the large minibatch, wherein the formed plurality of minibatches include at least one minibatch having the optimal minibatch size.

19. The method of claim 16, further comprising:
generating program binaries for the selected minibatch size and for a plurality of minibatch sizes less than the selected minibatch size, wherein program binaries for a minibatch size less than the selected minibatch size are configured to map input data, for the inferences in a minibatch of the minibatch size less than the selected minibatch size, to the processing elements having the weights and biases for the selected minibatch size.

20. The method of claim 19, wherein the program binaries generated for the minibatch sizes less than the selected minibatch size constrain a mapping of input data to the processing elements for processing dimensions related to applying the weights and biases for the selected minibatch size, and wherein the program binaries optimize work division with respect to the minibatch size less than the selected minibatch size for operations unrelated related to applying the weights and the biases.
